(19) United States
(12) Patent Application Publication
(10) Pub. No.: US 2022/0242398 A1
(43) Pub. Date: Aug. 4, 2022

(54) CONTROL DEVICE AND VEHICLE

(71) Applicant: HONDA MOTOR CO., LTD., Tokyo (JP)

(72) Inventors: Hiroshi Tagami, Tokyo (JP); Yoshihiro Sunaga, Tokyo (JP)

(21) Appl. No.: 17/588,382

(22) Filed: Jan. 31, 2022

(30) Foreign Application Priority Data
Feb. 4, 2021 (JP) 2021-016664

(51) Int. Cl. B60W 20/40; B60K 6/442; B60W 20/30; B60W 20/20

(52) U.S. Cl. CPC B60W 20/40; B60K 6/442; B60W 2510/0661; B60W 20/20; B60W 20/30

(57) ABSTRACT

Provided is a control device for a vehicle, the vehicle including an internal combustion engine, a generator, a battery, and a motor, in which, in a case where the internal combination engine is in operation under a state in which the internal combustion engine and the drive wheel are not mechanically connected to each other, when exhaust gas recirculation is performed and a number of rotations and a torque of the internal combustion engine are switched from a first state to a second state, and in which the control device determines whether to execute an assistance operation or a non-assistance operation.

### CROSS-REFERENCE TO RELATED APPLICATION

The application is based on Japanese Patent Application No. 2021-016664 filed on Feb. 4, 2021, the content of which incorporated herein by reference.

### BACKGROUND

### Field of the Invention

The present invention relates to a control device and a vehicle.

### Description of Related Art

The technology of controlling the number of rotations and a torque of an internal combustion engine mounted on a hybrid vehicle is known. For example, Japanese Patent Application Laid-Open No. 2018-127961 discloses a hybrid vehicle that has reduced a variation in the number of rotations and the torque at the time of changing an operation condition. This technology involves switching the operation condition among a plurality of operation lines when the number of rotations and the torque of the internal combustion engine satisfy a predetermined condition.

### SUMMARY

However, in the technology described in Japanese Patent Application Laid-Open No. 2018-127961, the timing of enabling switching of the operation line of the internal combustion engine is limited. In this manner, the related art cannot reduce the strange feeling felt by an occupant of the vehicle in some cases while at the same time switching the operation line of the internal combustion engine irrespective of the operation point of the internal combustion engine.

The present invention has been made in view of the above-mentioned circumstances, and has an object to provide a control device and a vehicle capable of reducing the strange feeling felt by an occupant of the vehicle while at the same time switching the operation line of the internal combustion engine irrespective of the operation point of the internal combustion engine.

A control device and a vehicle according to the present invention adopt the following configuration.

(1): According to one aspect of the present invention, there is provided a control device for a vehicle, the vehicle including an internal combustion engine, a generator capable of being rotated by the internal combustion engine, a battery that stores power generated by rotation of the generator, and a motor that is supplied with power from the battery and outputs a driving force to a drive wheel, in which, in a case where the internal combination engine is in operation under a state in which the internal combustion engine and the drive wheel are not mechanically connected to each other, when exhaust gas recirculation that causes exhaust gas discharged by the internal combustion engine to circulate to the internal combustion engine is performed and a first state, which operates the internal combustion engine by setting a number of rotations and a torque of the internal combustion engine to a first number of rotations and a first torque based on a requested output and a first optimum fuel consumption operation line that considers the exhaust gas recirculation, is switched to a second state that does not execute the exhaust gas recirculation, the control device determines, at least based on an output of the battery, whether to execute: an assistance operation of: setting the number of rotations of the internal combustion engine to a number of rotations closer to the first number of rotations than a second number of rotations that is based on the requested output and a second optimum fuel consumption operation line that does not consider the exhaust gas recirculation; setting the torque of the internal combustion engine to a second torque smaller than the first torque to operate the internal combustion engine; and causing the battery to output power corresponding to an insufficient output with respect to the first torque; or a non-assistance operation of keeping the number of rotations and the torque of the internal combustion engine at the first number of rotations and the first torque to operate the internal combustion engine, and in which the first optimum fuel consumption operation line indicates a larger torque for the same number of rotations than the second optimum fuel consumption operation line.

(2): In the aspect (1), the output of the battery is calculated based on a state of charge and a temperature of the battery, and the control device determines to execute the assistance operation when the output of the battery is equal to or larger than a threshold value, or determines to execute the non-assistance operation when the output of the battery becomes smaller than the threshold value.

(3): In the aspect (2), the control device switches the non-assistance operation to the assistance operation when the output of the battery becomes equal to or larger than the threshold value after the output of the battery becomes smaller than the threshold value and the non-assistance operation is executed.

(4) In the aspect (1), the assistance operation is an operation of setting the number of rotations of the internal combustion engine to the first number of rotations.

(5): In the aspect (1), the second torque is a torque corresponding to the first number of rotations in the second optimum fuel consumption operation line.

(6): According to another aspect of the present invention, there is provided a vehicle including: an internal combustion engine; a generator capable of being rotated by the internal combustion engine; a battery that stores power generated by rotation of the generator; a motor that is supplied with power from the battery and outputs a driving force to a drive wheel; and a control device, in which, in a case where the internal combination engine is in operation under a state in which the internal combustion engine and the drive wheel are not mechanically connected to each other, when exhaust gas recirculation that causes exhaust gas discharged by the internal combustion engine to circulate to the internal combustion engine is performed and a first state, which operates the internal combustion engine by setting a number of rotations and a torque of the internal combustion engine to a first number of rotations and a first torque based on a requested output and a first optimum fuel consumption operation line that considers the exhaust gas recirculation, is switched to a second state that does not execute the exhaust gas recirculation, the control device determines, at least based on an output of the battery, whether to execute: an assistance operation of: setting the number of rotations of the internal combustion engine to a number of rotations closer to the first number of rotations than a second number of rotations that is based on the requested output and a second optimum fuel consumption operation line that does not consider the exhaust gas recirculation; setting the torque of the internal combustion engine to a second torque smaller than the first torque to operate the internal combustion engine; and causing the battery to output power corresponding to an insufficient output with respect to the first torque; or a non-assistance operation of keeping the number of rotations and the torque of the internal combustion engine at the first number of rotations and the first torque to operate the internal combustion engine, and in which the first optimum fuel consumption operation line indicates a larger torque for the same number of rotations than the second optimum fuel consumption operation line.

According to the aspects of (1) to (5), it is possible to reduce the strange feeling felt by an occupant of the vehicle while at the same time switching the operation line of the internal combustion engine irrespective of the operation point of the internal combustion engine.

### BRIEF DESCRIPTION OF THE DRAWINGS

FIG. 1 is a diagram illustrating an example of a configuration of a vehicle M according to this embodiment.

FIG. 2 is a diagram illustrating an example of a functional configuration of a control device.

FIG. 3 is a diagram illustrating an example of a combination of a torque and the number of rotations of an engine that achieves optimum fuel consumption in both of a case in which an EGR (Exhaust Gas Recirculation) device executes exhaust gas recirculation and a case in which the EGR device does not execute exhaust gas recirculation.

FIG. 4 is a diagram illustrating an example of an output characteristic of a battery with respect to an SoC (State of Charge) and a temperature of the battery.

FIG. 5 is a flow chart illustrating an example of a flow of operations to be executed by the control device.

FIG. 6 is a flow chart illustrating an example of a method of determining whether or not an engine controller sets an engine on.

FIG. 7 is a flow chart illustrating an example of a method of determining whether or not an EGR controller executes EGR.

FIG. 8 is a flow chart illustrating an example of a method of determining whether or not the engine can output a small torque in a non-EGR state by a hybrid controller.

FIG. 9 is a timing chart illustrating an example of transition of a torque output by the engine depending on the situation of execution of exhaust gas recirculation and the state of SoC.

### DESCRIPTION OF EMBODIMENTS

Now, description is given of a control device and a vehicle according to embodiments of the present invention with reference to the drawings.

[Overall Configuration]

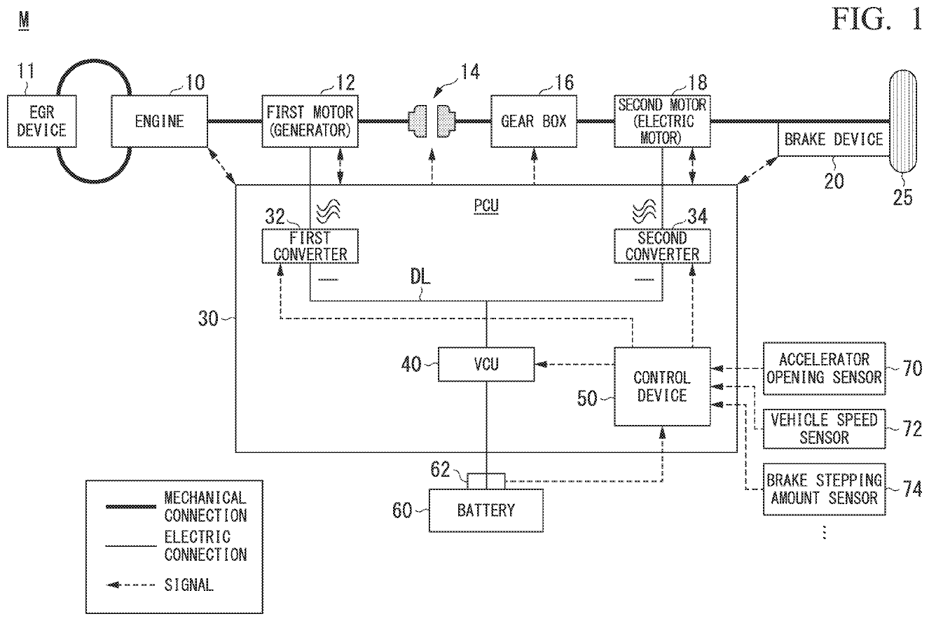

FIG. 1 is a diagram illustrating an example of a configuration of a vehicle M according to this embodiment. The vehicle M having the illustrated configuration is a hybrid vehicle that can switch between a series hybrid mode and a parallel hybrid mode. The series hybrid mode is a mode in which an engine and a drive wheel are not connected to each other mechanically, and a driving force output by the engine is used for power generation by a generator in a dedicated manner, and the generated power is supplied to an electric motor for traveling. The parallel hybrid mode is a mode in which the engine and the drive wheel can be connected to each other mechanically (or through fluid such as torque convertor), and a driving force output by the engine can be transmitted to a drive wheel or used for power generation. In the vehicle M having the configuration illustrated in FIG. 1, the series hybrid mode and the parallel hybrid mode can be switched therebetween by connecting or disconnecting a lock-up clutch 14.

As illustrated in FIG. 1, the vehicle M includes, for example, an engine 10, an EGR device 11, a first motor (generator) 12, a lock-up clutch 14, a gear box 16, a second motor (electric motor) 18, a braking device 20, a drive wheel 25, a PCU (Power Control Unit) 30, a battery 60, a battery sensor 62 such as a voltage sensor, a current sensor, and a temperature sensor, an accelerator opening sensor 70, a vehicle speed sensor 72, a brake stepping amount sensor 74, and other vehicle sensors. This vehicle M includes at least the engine 10, the second motor 18, and the battery 60 as a driving source.

The engine 10 is an internal combustion engine that outputs a driving force by burning a fuel such as gasoline. The engine 10 is a reciprocating engine such as a combustion chamber, a cylinder and a piston, an intake valve, an exhaust valve, a fuel injector, an ignition plug, a connecting rod, and a crankshaft. Alternatively, the engine 10 may be a rotary engine.

The EGR device 11 is a device that returns a part of exhaust gas after combustion of the engine 10 as exhaust gas recirculation (EGR) gas into the combustion chamber of the engine 10. The EGR device 11 is provided so as to connect the intake passage of the combustion chamber to the exhaust passage. Although the illustration is omitted in FIG. 1, the EGR device 11 includes at least an EGR passage that distributes EGR gas and an EGR valve that limits the amount of returned EGR gas, and adjusts the amount of returned EGR gas (including the amount equivalent to zero, i.e., shutting off EGR gas) according to the commands from the PCU 30.

The first motor 12 is, for example, a three-phase AC generator. The first motor 12 has a rotor connected to the output shaft (e.g., crankshaft) of the engine 10, and generates power by using a driving force output by the engine 10. The output shaft of the engine 10 and the rotor of the first motor 12 are connected to the side of the drive wheel 25 via the lock-up clutch 14.

The lock-up clutch 14 switches between a state in which the output shaft of the engine 10 and the rotor of first motor 12 are connected to the side of the drive wheel 25 and a state in which the output shaft of the engine 10 and the rotor of first motor 12 are disconnected from the side of drive wheel 25 in response to a command from the PCU 30.

The gear box 16 is a transmission. The gear box 16 shifts a driving force output by the engine 10 and transmits the driving force to the drive wheel 25. The gear ratio of the gear box 16 is specified by the PCU 30.

The second motor 18 is, for example, a three-phase AC motor. The rotor of the second motor 18 is connected to the drive wheel 25. The rotor of second motor 18 is connected to the drive wheel 25. The second motor 18 outputs a driving force to the drive wheel 25 using supplied power. Furthermore, the second motor 18 generates power by using the kinetic energy of the vehicle M when the vehicle M decelerates, and stores the generated power into the battery 60 via the second converter 34 and the VCU described below.

The braking device 20 includes, for example, a brake caliper, a cylinder that transmits hydraulic pressure to the brake caliper, and an electric motor that generates hydraulic pressure to the cylinder. The braking device 20 may include, as a backup, a mechanism that transmits the hydraulic pressure generated by the operation of the brake pedal to the cylinder via a master cylinder. The braking device 20 is not limited to the configuration described above, and may also be an electronically controlled hydraulic braking device that transmits the hydraulic pressure of the master cylinder to the cylinder.

The PCU 30 includes, for example, a first converter 32, a second converter 34, a VCU (Voltage Control Unit) 40, and a control device 50. The configuration of providing these components as a single PCU 30 is only an example, and these components may be arranged in a distributed manner.

The first converter 32 and the second converter 34 are, for example, AC-DC converters. The terminals of the first and second converters 32 and 34 on the direct current side are connected to a direct current (DC) link DL. The battery 60 is connected to the DC link via a VCU 40. The first converter 32 converts the alternating current generated by the first motor 12 to direct current and outputs the direct current to the DC link DL, or converts the direct current supplied via the DC link DL to alternating current and supplies the alternating current to the first motor 12. Similarly, the second converter 34 converts the alternating current generated by the second motor 18 to direct current and outputs the direct current to the DC link DL, or converts the direct current supplied via the DC link DL to alternating current and supplies the alternating current to the second motor 18.

The VCU 40 is, for example, a DC-DC converter. The VCU 40 boosts power supplied by the battery 60, and outputs the power to the DC link DL.

The function of the control device 50 is described later. The battery 60 is, for example, a secondary battery such as a lithium-ion battery.

The accelerator opening sensor 7 is mounted to an acceleration pedal, which is an example of an operator that receives an acceleration command from the driver, detects an operation amount of the acceleration pedal, and outputs the operation amount to the control device 50 as an accelerator opening. The vehicle speed sensor 72 includes, for example, a wheel speed sensor mounted to each wheel and a speed calculator. The wheel speed sensor 72 integrates the wheel speeds detected by the wheel speed sensors to derive the speed of the vehicle M (vehicle speed), and outputs the vehicle speed to the control device 50. The brake stepping amount sensor 74 is mounted to a brake pedal, which is an example of an operator that receives a deceleration command or a stop command from the driver, detects the operation amount of the brake pedal, and outputs the operation amount of the brake pedal to the control device 50 as a brake stepping amount.

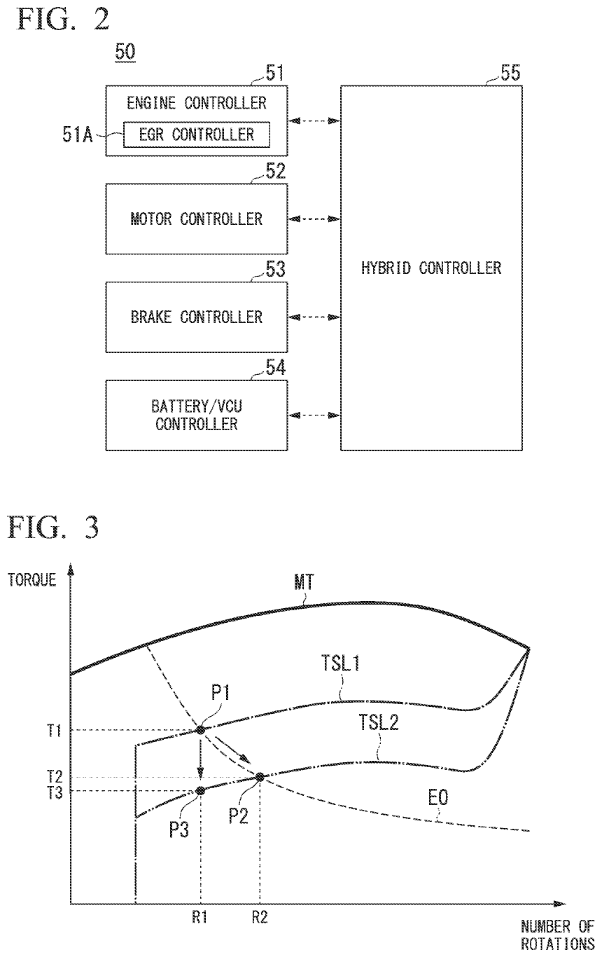

FIG. 2 is a diagram illustrating an example of a functional configuration of the control device 50. The control device 50 includes, for example, an engine controller 51, a motor controller 52, a brake controller 53 a battery/VCU controller 54, and a hybrid control unit 55. These components are implemented by a hardware processor such as a CPU (Central Processing Unit) executing a program (software). A part or all of these components may be implemented by an LSI (Large Scale Integration), an ASIC (Application Specific Integrated Circuit), an FPGA (Field-Field Integrated Circuit), a GPU (Graphics Processing Unit), or other hardware (including circuitry), or may be implemented through cooperation between software and hardware.

Furthermore, each of the engine controller 51, the motor controller 52, the brake controller 53, and the battery/VCU controller 54 may be replaced with a control device separate from the hybrid controller 55, such as an engine ECU (Electronic Control Unit), a motor ECU, a brake ECU, or a battery ECU.

Furthermore, the engine controller 51 performs ignition control, throttle opening control, fuel injection control, fuel cut control, and the like for the engine 10 in response to a command from the hybrid controller 55. For example, the engine controller 51 receives command values for the number of rotations and torque of the engine 10 from the hybrid controller 55, and controls the engine 10 to operate in accordance with the command values.

The engine controller 51 further includes an EGR controller 51A. The EGR controller 51A determines whether or not to execute EGR on the basis of the state of the engine 10, and when the EGR controller 51A has determined to execute EGR, the EGR controller 51A causes the EGR device 11 to execute EGR. The state of the engine 10 includes, for example, the warming-up status of the engine 10, the execution status of feedback control of the air-fuel ratio, the execution status of fuel cut, and the pressure of the intake manifold (hereinafter also referred to as “intake manifold pressure”).

The motor controller 52 performs switching control of the first converter 32 and/or the second converter 34 in accordance with a command from the hybrid controller 55.

The brake controller 53 controls the braking device 20 in accordance with a command from the hybrid controller 55.

The battery/VCU controller 54 calculates the SOC (State Of Charge) and temperature of the battery 60 based on an output from the battery sensor 62 mounted to the battery 60, and outputs the SOC and the temperature to the hybrid controller 55. Furthermore, the battery/VCU controller 54 operates the VCU 40 to increase the voltage of the DC link DL in accordance with a command from the hybrid controller 55.

The hybrid controller 55 determines a driving mode based on outputs from the accelerator opening sensor 70, the vehicle speed sensor 72, and the brake stepping amount sensor 74, and outputs commands to the engine controller 51, the motor controller 52, the brake controller 53, and the battery/VCU controller 54 in accordance with the driving mode. The hybrid controller 55 determines command values for the number of rotations and torque of the engine 10 in each driving mode, and transmits the determined command values to the engine controller 51.

[Various Kinds of Driving Modes]

Now, description is given of the driving mode to be determined by the hybrid controller 55. The driving mode includes the following modes.

(1) Series Hybrid Driving Mode (ECVT)

In the series hybrid driving mode, the hybrid controller 55 sets the lock-up clutch 14 to a separation state, supplies fuel to the engine 10 to operate, and provides power generated by the first motor 12 to the battery 60 and the second motor 18. Then, power supplied from the first motor 12 or the battery 60 is used to drive the second motor 18, and a driving force supplied from the second motor 18 is used to cause the vehicle M to travel. The series hybrid driving mode is an example of a mode in which “the internal combustion engine is operating under a state in which the internal combustion engine and the drive wheel are not mechanically connected to each other”.

(2) EV Driving Mode (EV)

In the EV driving mode, the hybrid controller 55 sets the lock-up clutch 14 to a separation state, uses power supplied from the battery 60 to drive the second motor 18, and causes the vehicle M to travel by a driving force supplied from the second motor 18.

(3) Engine Driving Mode (LU)

In the engine driving mode, the hybrid controller 55 sets the lock-up clutch 14 to a connection state, supplies fuel to the engine 10 to operate, causes at least a part of the driving force output from the engine 10 to be transmitted to the drive wheel 25, and causes the vehicle M to travel. In this case, the first motor 12 may or may not generate power.

(4) Regeneration

At the time of regeneration, the hybrid controller 55 sets the lock-up clutch 14 to a separation state, and causes the second motor 18 to generate power by using kinetic energy of the vehicle M. Power generated at the time of regeneration is stored in the battery 60 or discarded by a discharge operation.

[Outline of Operation Performed by Control Device 50]

Next, an outline of an operation to be executed by the control device 50 is described with reference to FIG. 3. It is assumed that the operation of the control device 50 described below is executed while the vehicle M is traveling in the ECVT mode unless otherwise specified. In this case, the engine 10 is not directly connected to the drive wheel 25, and thus the control device 50 can select a numerous number of combinations of the number of rotations and torques required for achieving a predetermined output of the engine 10 without being restricted by the vehicle speed.

FIG. 3 is a diagram illustrating an example of a combination of the torque and the number of rotations of the engine 10 that achieves optimum fuel consumption in both of a case in which the EGR device 11 executes EGR and a case in which the EGR device 11 does not execute EGR. In FIG. 3. MT represents a line indicating a combination of the maximum torque that can be achieved by the vehicle M and the number of rotations at that time. TSL1 represents a line (one example of “first optimum fuel consumption operation line”) indicating a combination of the torque and the number of rotations that achieves the optimum fuel consumption in a case where the EGR device 11 executes EGR. TSL2 represents a line (one example of “second optimum fuel consumption operation line”) indicating a combination of the torque and the number of rotations that achieves the optimum fuel consumption in a case where the EGR device 11 does not execute EGR. EO represents a line indicating a combination of the torque and the number of rotations that achieves an equal output of the engine 10. The output in this case is calculated by multiplying the toque by the number of rotations.

Now, in FIG. 3, it is assumed that, under a state in which the EGR device 11 has executed EGR to cause the torque and the number of rotations of the engine 10 to reach a point P1(R1, T1) on the first optimum fuel consumption operation line TSL1, the EGR controller 51A has determined to stop EGR, and the EGR device 11 has stopped EGR in accordance with this determination. In this case, the control device 50 usually moves the combination of the torque and the number of rotations from the point P1(R1, T1) to a point P2(R2,T2) on the second optimum fuel consumption operation line that achieves an output that is equal to an output of the point P1. However, in that case, the number of rotations of the engine 10 changes from R1 to R2, with the result that the occupant of the vehicle M may feel strange.

In view of the above, in this embodiment, the EGR device 11 stops EGR, and when the output of the battery 60 is equal to or larger than a threshold value, the control device 50 sets only the torque to a torque corresponding to the number of rotations in the second optimum fuel consumption operation line TSL2 without changing the number of rotations. That is, the control device 50 moves the combination of the torque and the number of rotations from the point P1(R1, T1) to a point P3(R1, T3) on the second optimum fuel consumption operation line TSL2. In this case, the output of the engine 10 at the point P3(R1, T3) is R1×T3, which is smaller than the original output R1×T1. Thus, the control device 50 executes an assistance operation of causing the battery 60 to output power corresponding to a difference R1×T1−R1×T3 between the output R1×T1 before movement and the output R1×T3 after movement. As a result, it is possible to achieve optimum fuel consumption in the non-EGR state without causing an occupant to feel strange due to a change in number of rotations while at the same time satisfying a requested output. The number of rotations R1 is an example of “first number of rotations”, the number of rotations R2 is an example of “second number of rotations”, the torque T1 is an example of “first torque”, and the torque T3 is an example of “second torque”.

On the other hand, when the EGR device 11 has stopped EGR and the output of the battery 60 is smaller than the threshold value, the control device 50 executes a non-assistance operation of keeping the combination of the torque and the number of rotations at the point P1(R1, T1). In this case, although the requested output is satisfied, the combination of the torque and the number of rotations is still at the point P1(R1, T1), which deviates from the second optimum fuel consumption operation line TSL2, resulting in decrease in fuel consumption.

In the related art, in a case where the output of the battery 60 is smaller than the threshold value and the control device 50 has executed the non-assistance operation, even when the output of the battery 60 becomes equal to or larger than the threshold value again, the non-assistance operation is continued. On the other hand, in this embodiment, when the output of the battery 60 becomes equal to or larger than the threshold value again after the output of the battery 60 becomes smaller than the threshold value and the non-assistance operation is performed, the non-assistance operation is switched to the assistance operation. That is, the combination of the torque and the number of rotations is switched from the point P1(R1, T1) to the point P3(R1, T3), and the battery 60 outputs power corresponding to insufficient output. As a result, it is possible to achieve optimum fuel consumption by flexibly switching the combination of the torque and the number of rotations depending on the output of the battery 60 without causing an occupant of the vehicle M to feel strange.

In the description given above, the control device 50 keeps the number of rotations R1 as it is at the time of execution of the assistance operation. However, the present invention is not limited to this configuration, and the control device 50 may change the number of rotations R1 within a range that does not cause an occupant of the vehicle M to feel strange. Furthermore, in the description given above, the control device 50 sets the torque T1 to the torque T3. However, the present invention is not limited to this configuration, and the control device 50 may set the torque T1 to a smaller value in general.

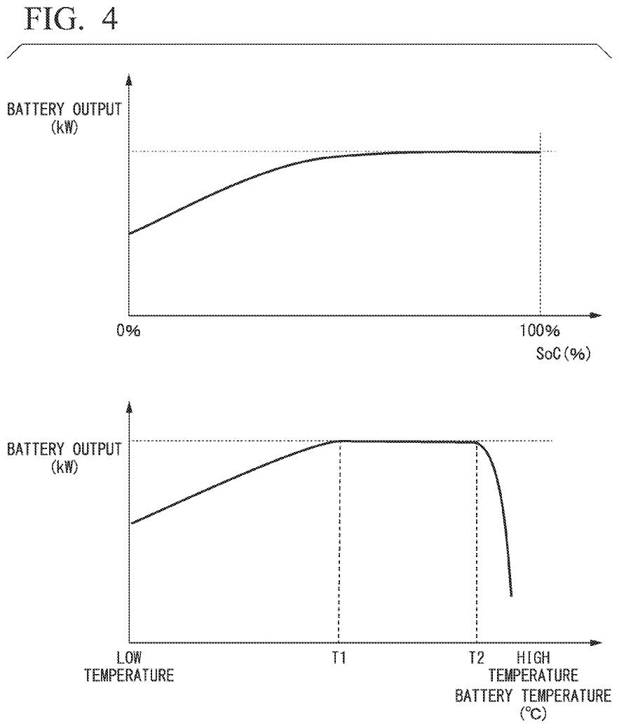

Furthermore, in the description given above, the “output of the battery 60” means an amount of power that can be output by the battery 60, which is calculated based on the SoC and temperature of the battery 60. FIG. 4 is a diagram illustrating an example of an output characteristic of the battery 60 with respect to the SoC and temperature of the battery 60. The upper part of FIG. 4 represents an output characteristic with respect to the SoC of the battery 60, and the output of the battery 60 increases monotonously with respect to the SoC. On the other hand, the lower part of FIG. 4 represents an output characteristic with respect to the temperature of the battery 60, and although the output of the battery 60 increases monotonously to the temperature T1, a fixed maximum value is reached between the temperature T1 and the temperature T2, and the output of the battery 60 decreases rapidly after the temperature T2. That is, in a case where the temperature of the battery 60 is high, even when the SoC is high, the output of the battery 60 takes a small value, and as a result, the non-assistance operation is likely to be executed.

[Flow of Operations Executed by Control Device 50]

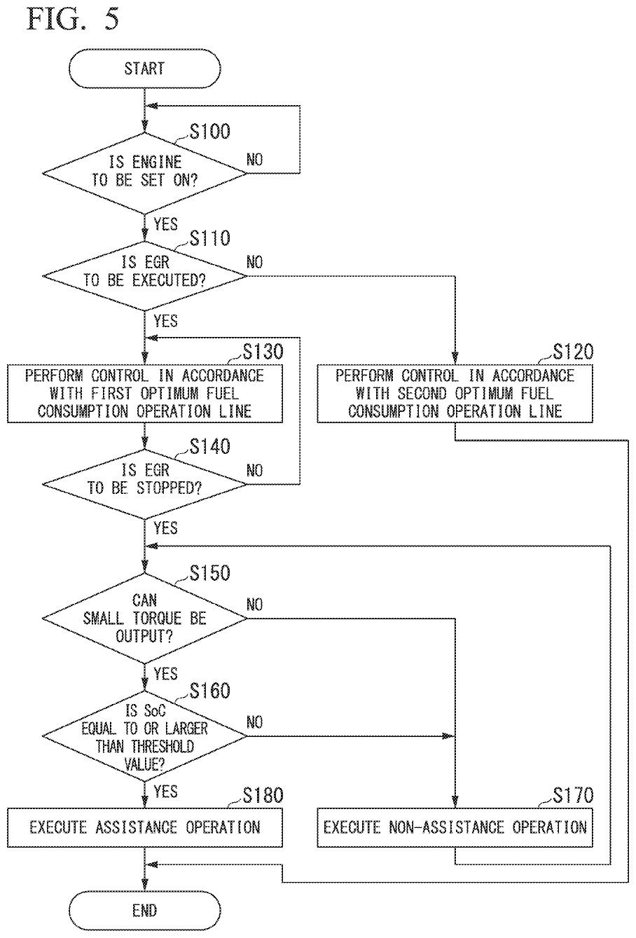

Next, a flow of operations to be executed by the control device 50 is described with reference to FIG. 5. FIG. 5 is a flow chart illustrating an example of a flow of operations to be executed by the control device 50. The processing of this flow chart is executed every predetermined control cycle.

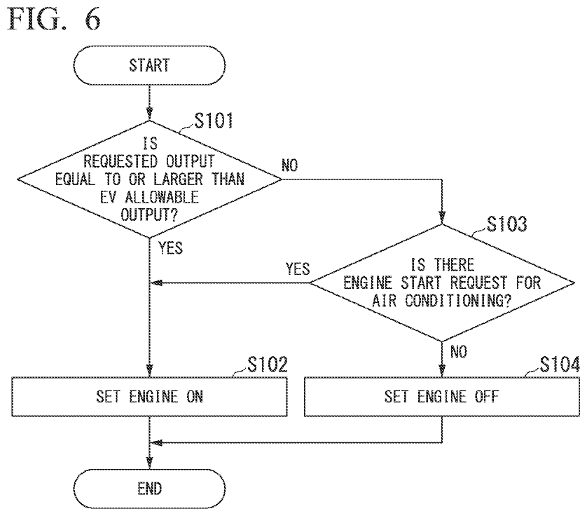

First, the engine controller 51 determines whether or not to set the engine 10 on (Step S100). The method of determining whether or not to set the engine 10 is described later with reference to FIG. 6. When it is determined that the engine 10 is not set on, the engine controller 51 repeats the processing of Step S100. When it is determined that the engine 10 is set on, the engine controller 51 ignites and operates the engine 10.

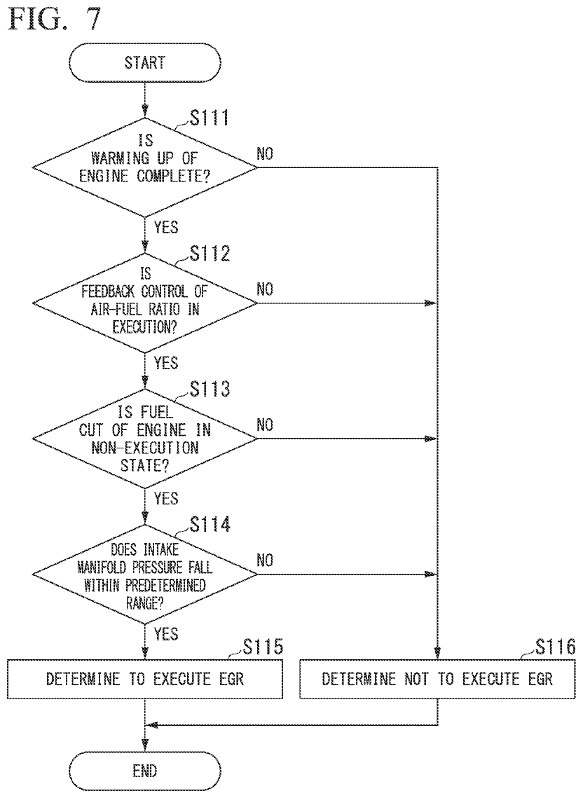

Next, the EGR controller 51A determines whether or not to execute EGR (Step S110). The method of determining whether or not to execute EGR is described later with reference to FIG. 7. When it is determined that EGR is not executed, the control device 50 operates the engine 10 in accordance with the second optimum fuel consumption operation line TSL2 (Step S120). Specifically, the hybrid controller 55 sets the number of rotations and the torque of the engine 10 to an intersection between the requested output and the second optimum fuel consumption operation line TSL2, and operates the engine 10 in accordance with the number of rotations and the torque.

On the other hand, when it is determined EGR is executed, the control device 50 operates the engine 10 in accordance with the first optimum fuel consumption operation line TSL1 (Step S130). Specifically, the hybrid controller 55 sets the number of rotations and the torque of the engine 10 to an intersection between the requested output and the first optimum fuel consumption operation line TSL1, and operates the engine 10 in accordance with the number of rotations and the torque.

Next, the EGR controller 51A determines whether or not to stop EGR (Step S140). The method of determining whether or not to stop EGR is similar to the method of determining whether or not to execute EGR. When it is determined that EGR is not stopped, the control device 50 continues the operation of the engine 10 in accordance with the first optimum fuel consumption operation line TSL1.

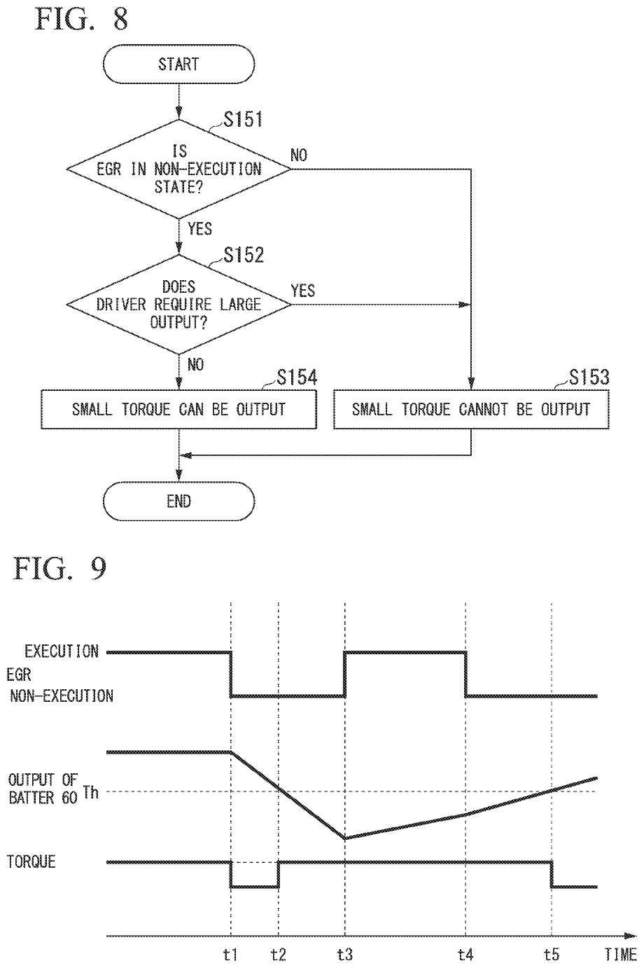

When it is determined that EGR is stopped, the EGR controller 51A stops EGR, and the control device 50 determines whether or not the engine 10 can output a small torque (Step S150). The method of determining whether or not the engine 10 can output a small torque is described later with reference to FIG. 8.

When it is determined that the engine 10 cannot output a small torque, the control device 50 executes the non-assistance operation of keeping the combination of the torque and the number of rotations (Step S170). That is, the control device 50 still sets the combination of the torque and the number of rotations on the first optimum fuel consumption operation line TSL1 irrespective of the state in which EGR is stopped, and does not move the combination of the torque and the number of rotations onto the second optimum fuel consumption operation line TSL2. As a result, the fuel consumption deteriorates while the requested output is satisfied without causing the occupant of the vehicle M to feel strange. After that, the control device 50 executes determination of Step S150 again.

On the other hand, when it is determined that the engine 10 can output a small torque, the control device 50 determines whether or not the output of the battery 60 is equal to or larger than the threshold value (Step S160). When it is determined that the output of the battery 60 is smaller than the threshold value, the control device 50 executes the non-assistance operation of keeping the combination of the torque and the number of rotations (Step S170). After that, the control device 50 executes determination of Step S150 again.

When it is determined that the output of the battery 60 is equal to or larger than the threshold value, the control device 50 does not change the number of rotations, but executes the assistance operation of setting only the torque to a torque corresponding to the number of rotations on the second optimum fuel consumption operation line TSL2, and causing the battery 60 to output power corresponding to insufficient output (Step S180). As a result, it is possible to achieve optimum fuel consumption in a non-EGR state without causing an occupant to feel strange due to a change in number of rotations while satisfying the requested output. Then, the processing of the flow chart of FIG. 5 is finished.

According to the processing of the flow chart described above, in a case where EGR is stopped after EGR is executed to operate the engine 10 in accordance with the first optimum fuel consumption operation line, when the engine 10 can output a small torque and the output of the battery 60 is equal to or larger than the threshold value, the control device 50 executes the assistance operation. On the other hand, when the engine 10 cannot output a small torque or the output of the battery 60 is smaller than the threshold value, the control device 50 executes the non-assistance operation, and after that, when the engine 10 can output a small torque and the output of the battery 60 is equal to or larger than the threshold value, the non-assistance operation is switched to the assistance operation. As a result, it is possible to achieve optimum fuel consumption by flexibly switching the combination of the torque and the number of rotations depending on the output of the battery 60 without causing an occupant of the vehicle M to feel strange.

In the flow chart of FIG. 5, two conditions, namely, the condition of whether or not the engine 10 can output a small torque and the condition of whether or not the output of the battery 60 is equal to or larger than the threshold value are used for determining whether to execute the assistance operation or the non-assistance operation. However, the present invention is not limited to this configuration, and this determination may be performed at least based on the output of the battery 60.

Next, description is given of the method of determining whether to set the engine 10 on with reference to FIG. 6. FIG. 6 is a flow chart illustrating an example of the method of determining whether or not the engine controller 51 sets the engine 10 on.

First, the engine controller 51 determines whether or not the requested output is larger than an EV allowable output. For example, the EV allowable output may be set to the maximum output or an output for which the deceleration speed of the SoC is not equal to or larger than a predetermined value. When it is determined that the requested output is larger than the EV allowable output, the engine controller 51 determines to set the engine on (Step S102).

On the other hand, when it is determined that the requested output is equal to or smaller than the EV allowable output, the engine controller 51 determines whether or not there is an engine start request for executing air conditioning (Step S103). When it is determined that there is an engine start request for executing air conditioning, the engine controller 51 determines to set the engine on, whereas when it is determined that there is no engine start request for executing air conditioning, the engine controller 51 determines to set the engine off (Step S104). Then, the processing of the flow chart of FIG. 6 is finished.

Next, description is given of the method of determining whether to execute EGR with reference to FIG. 7. FIG. 7 is a flow chart illustrating an example of the method of determining whether or not the EGR controller 51A executes EGR.

First, the EGR controller 51A determines whether or not warming up of the engine 10 is complete (Step S111). When it is determined that warming up of the engine 10 is not complete, the EGR controller 51A determines not to execute EGR (Step S116). On the other hand, when it is determined that warming up of the engine 10 is complete, the EGR controller 51A next determines whether or not feedback control of the air-fuel ratio is in execution (Step S112).

When it is determined that feedback control of the air-fuel ratio is not in execution, the EGR controller 51A determines not to execute EGR. On the other hand, when it is determined that feedback control of the air-fuel ratio is in execution, the EGR controller 51A next determines whether or not fuel cut of the engine 10 is not in execution (Step S113).

When it is not determined that fuel cut of the engine 10 is not in execution, the EGR controller 51A determines not to execute EGR. On the other hand, when it is determined that fuel cut of the engine 10 is not in execution, the EGR controller 51A next determines whether or not the intake manifold pressure falls within a predetermined range (Step S114).

When it is determined that the intake manifold pressure does not fall within the predetermined range, the EGR controller 51A determines not to execute EGR. On the other hand, when it is determined that the intake manifold pressure falls within the predetermined range, the EGR controller 51A determines to execute EGR (Step S115). Then, the processing of the flow chart of FIG. 7 is finished. The conditions of from Step S111 to Step S114 described above are conditions necessary for normally executing EGR.

The flow chart of FIG. 7 relates to the method of determining whether to execute EGR, but this flow chart may also be used as the method of determining whether to stop EGR in the flow chart of FIG. 5 by changing “execute EGR” of Step S115 to “not to stop EGR” and changing “not to execute EGR” to “stop EGR”.

Next, description is given of the method of determining whether the engine 10 can output a small torque in a non-EGR state with reference to FIG. 8. FIG. 8 is a flow chart illustrating an example of the method of determining whether or not the engine 10 can output a small torque in a non-EGR state by the hybrid controller 55.

First, the hybrid controller 55 determines whether or not EGR is not in execution (Step S151). This condition is used for checking whether the current status is a non-EGR state. When it is determined that EGR is not in execution, the hybrid controller 55 determines that the engine 10 cannot output a small torque (Step S153). On the other hand, when it is determined that EGR is not in execution, the hybrid controller 55 determines whether or not the driver requires a large output (Step S152). Whether or not the driver requires a large output can be determined by the accelerator opening detected by the accelerator opening sensor 70, for example.

When it is not determined that the driver does not require a large output, this means that the consumption of the battery 60 is large or likely to be large in the future, with the result that the battery 60 has a difficulty in compensating for the amount of decrease in torque caused by the engine 10. Thus, the hybrid controller 55 determines that the engine 10 cannot output a small torque.

On the other hand, when it is determined that the driver does not require a large output, this means that the consumption of the battery 60 is small or likely to be small in the future, with the result that the battery 60 can compensate for the amount of decrease in torque caused by the engine 10 with a margin. Thus, the hybrid controller 55 determines that the engine 10 can output a small torque (Step S154). Then, the processing of the flow chart of FIG. 8 is finished.

Next, description is given of transition of the torque output by the engine 10 in an exemplary scene of this embodiment with reference to FIG. 9. FIG. 9 is a timing chart illustrating an example of transition of the torque output by the engine 10 depending on the situation of execution of EGR and the output of the battery 60. Similarly to the flow chart described above, the scene of FIG. 9 is based on the assumption that the vehicle M is in an ECVT mode. Furthermore, it is assumed that the output required for the vehicle M is constant.

First, before a time point t1, EGR is executed, the output of the battery 60 is equal to or larger than a threshold value Th, and the engine 10 outputs the number of rotations and the torque on the first optimum fuel consumption operation line TSL1. Next at a time point t1, EGR is stopped. At this time, the output of the battery 60 is equal to or larger than the threshold value Th, and thus the control device 50 executes the assistance operation of changing the torque to a value corresponding to the original number of rotations on the second optimum fuel consumption operation line TSL2, and causing the battery 60 to output power corresponding to an insufficient output.

Next, at a time point t2, as a result of the assistance operation that uses the battery 60, the output of the battery 60 is smaller than the threshold value Th. At this time, the control device 50 returns the torque to the value before the time point t1 to execute the non-assistance operation. That is, the number of rotations and the torque of the engine 10 are set to a point on the first optimum fuel consumption operation line TSL1, and fuel consumption becomes insufficient although the requested output is satisfied. Next, at a time point t3, EGR is resumed. At this time, the number of rotations and the torque of the engine 10 are on the first optimum fuel consumption operation line TSL1, and thus fuel consumption becomes sufficient while the requested output is satisfied.

Next, at a time point t4, EGR is stopped again. At this time, the output of the battery 60 is smaller than the threshold value Th, and thus the control device 50 executes the non-assistance operation of keeping the combination of the torque and the number of rotations on the first optimum fuel consumption operation line TSL1. Next, at a time point t5, the output of the battery 60 is equal to or larger than the threshold value Th, and thus the control device 50 executes the assistance operation of changing the torque to a value corresponding to the original number of rotations on the second optimum fuel consumption operation line TSL2, and causing the battery 60 to output power corresponding to an insufficient output.

According to the embodiment described above, in a case where EGR is stopped, when the output of the battery 60 is equal to or larger than a threshold value, the assistance operation that follows the second optimum fuel consumption operation line is executed, whereas when the output of the battery 60 is smaller than the threshold value, the non-assistance operation that follows the first optimum fuel consumption operation line is executed. After that, when the output of the battery 60 becomes equal to or larger than the threshold value again, the non-assistance operation is switched to the assistance operation. As a result, it is possible to reduce the strange feeling felt by an occupant of the vehicle while at the same time switching the operation line of the internal combustion engine irrespective of the operation point of the internal combustion engine.

This concludes the description of the embodiment for carrying out the present invention. The present invention is not limited to the embodiment in any manner, and various kinds of modifications and replacements can be made within a range that does not depart from the gist of the present invention.

What is claimed is:

1. A control device for a vehicle, the vehicle including an internal combustion engine, a generator capable of being rotated by the internal combustion engine, a battery that stores power generated by rotation of the generator, and a motor that is supplied with power from the battery and outputs a driving force to a drive wheel,
wherein, in a case where the internal combination engine is in operation under a state in which the internal combustion engine and the drive wheel are not mechanically connected to each other, when exhaust gas recirculation that causes exhaust gas discharged by the internal combustion engine to circulate to the internal combustion engine is performed and a first state, which operates the internal combustion engine by setting a number of rotations and a torque of the internal combustion engine to a first number of rotations and a first torque based on a requested output and a first optimum fuel consumption operation line that considers the exhaust gas recirculation, is switched to a second state that does not execute the exhaust gas recirculation, the control device determines, at least based on an output of the battery, whether to execute:
an assistance operation of:
setting the number of rotations of the internal combustion engine to a number of rotations closer to the first number of rotations than a second number of rotations that is based on the requested output and a second optimum fuel consumption operation line that does not consider the exhaust gas recirculation;
setting the torque of the internal combustion engine to a second torque smaller than the first torque to operate the internal combustion engine; and
causing the battery to output power corresponding to an insufficient output with respect to the first torque; or
a non-assistance operation of keeping the number of rotations and the torque of the internal combustion engine at the first number of rotations and the first torque to operate the internal combustion engine, and
wherein the first optimum fuel consumption operation line indicates a larger torque for the same number of rotations than the second optimum fuel consumption operation line.

2. The control device according to claim 1,
wherein the output of the battery is calculated based on a state of charge and a temperature of the battery,
wherein the control device determines to execute the assistance operation when the output of the battery is equal to or larger than a threshold value, or determines to execute the non-assistance operation when the output of the battery becomes smaller than the threshold value.

3. The control device according to claim 2, wherein the control device switches the non-assistance operation to the assistance operation when the output of the battery becomes equal to or larger than the threshold value after the output of the battery becomes smaller than the threshold value and the non-assistance operation is executed.

4. The control device according to claim 1, wherein the assistance operation is an operation of setting the number of rotations of the internal combustion engine to the first number of rotations.

5. The control device according to claim 1, wherein the second torque is a torque corresponding to the first number of rotations in the second optimum fuel consumption operation line.

6. A vehicle comprising:
an internal combustion engine;
a generator capable of being rotated by the internal combustion engine;
a battery that stores power generated by rotation of the generator;
a motor that is supplied with power from the battery and outputs a driving force to a drive wheel; and
a control device,
wherein, in a case where the internal combination engine is in operation under a state in which the internal combustion engine and the drive wheel are not mechanically connected to each other, when exhaust gas recirculation that causes exhaust gas discharged by the internal combustion engine to circulate to the internal combustion engine is performed and a first state, which operates the internal combustion engine by setting a number of rotations and a torque of the internal combustion engine to a first number of rotations and a first torque based on a requested output and a first optimum fuel consumption operation line that considers the exhaust gas recirculation, is switched to a second state that does not execute the exhaust gas recirculation, the control device determines, at least based on an output of the battery, whether to execute:
an assistance operation of:
setting the number of rotations of the internal combustion engine to a number of rotations closer to the first number of rotations than a second number of rotations that is based on the requested output and a second optimum fuel consumption operation line that does not consider the exhaust gas recirculation;
setting the torque of the internal combustion engine to a second torque smaller than the first torque to operate the internal combustion engine; and
causing the battery to output power corresponding to an insufficient output with respect to the first torque; or
a non-assistance operation of keeping the number of rotations and the torque of the internal combustion engine at the first number of rotations and the first torque to operate the internal combustion engine, and
wherein the first optimum fuel consumption operation line indicates a larger torque for the same number of rotations than the second optimum fuel consumption operation line.
